(19) United States
(12) Patent Application Publication
(10) Pub. No.: US 2007/0268196 A1
(43) Pub. Date: Nov. 22, 2007

(54) Receiving Antenna System Comprising Several Active Antennae

(75) Inventor: Herbert Steghafner, Tiefenbach (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Rohde & Schwarz GmbH & Co. KG, Muenchen (DE)

(21) Appl. No.: 10/577,411

(22) PCT Filed: Jul. 12, 2005
(86) PCT No.: PCT/EP05/07554

§ 371 Date: Jun. 20, 2007

(30) Foreign Application Priority Data
Aug. 13, 2004 (DE) 10 2004 039 439.3

(51) Int. Cl. H01Q 21/08

(52) U.S. Cl. 343/893

(57) ABSTRACT

A receiver antenna system of broad bandwidth including a plurality of active, vertical individual antennae, which have an electrically-active antenna height adapted to the respective received frequency range, is minimized with regard to the mutual electromagnetic coupling between the individual antennae, which are positioned at a small spacing distance.

Between the passive antenna structure and the active electronic elements, such as impedance converters and amplifier elements, active receiver antennae do not have interfaces with a constant surge impedance. In the case of passive antennae, the surge impedance of these interfaces must be adapted in the useful frequency range to the surge impedance of a normal line. This therefore reduces the bandwidth of the receiver antenna system as a whole in an undesirable manner.

If an antenna system is formed from several, active individual antennae, of which the respective electrical antenna height is adapted to the respective received frequency range of the individual antenna, in order to avoid deformed antenna patterns—“peaked antenna patterns”—, a broad-band, overall received-frequency range of the receiver antenna system built up from the several individual receiver-frequency ranges of the individual antennae can be achieved. The shortening of the electrical antenna height of the individual antenna can be implemented electrically by arranging impedance elements, for example, a parallel circuit consisting of an inductance and an ohmic resistor at given heights of the individual antenna. At low received frequencies, the inductance bridges the resistor, while the resistor is active at high received frequencies. It is therefore possible to adjust the electrical antenna height to the respective received frequency range of the individual antenna by an exact positioning of the impedance elements and a received-frequency-dependent parametrisation of the impedance elements.

A receiver antenna system consisting of several active individual antennae is disclosed in DE 34 37 727 A1. With the disclosed receiver antenna system, the individual antennae are positioned at relatively large spacing distances—up to a few hundred meters—from one another. The mutual electromagnetic couplings of the individual antennae, which impair the directivity, the efficiency and the antenna power gain of the receiver antenna system, are negligible with an arrangement of this kind. However, if a considerably more compact realization of a receiver antenna system is required with spacing distances between the individual antennae in the order of magnitude of a few centimetres, these mutual, electromagnetic couplings of the individual antennae are no longer negligible. In a disadvantageous manner, they lead to deformed antenna patterns of the individual antennae, to a mutual, negative influence on the base-point impedances and to unsymmetrical stresses on the individual antennae, which has the overall effect of impairing the quality of reception of the receiver antenna system.

The invention is therefore based on the object of providing a receiver antenna system with several active individual antennae with a small spacing distance, which provides a broad bandwidth.

This object is achieved by a receiver antenna system according to claim 1. Advantageous embodiments of the invention are specified in the dependent claims.

In order to suppress the above-named, disadvantageous effects, the currents in the individual antennae are decoupled from the electromagnetic couplings by the individual current-influencing parameters of the receiver antenna system in a received-frequency-dependent manner. The individual antennae of the receiver antenna system according to the invention are therefore designed by optimizing the current-influencing parameters of the receiver antenna system—frequency-dependent electrical antenna height (impedance elements on the radiators), antenna diameter, antenna spacing distances and input impedance of the active base-point electronics—in order to minimise the electromagnetic couplings of the individual antennae.

In this context, particular attention is paid to the arrangement of impedance elements within an individual antenna and also to the arrangement of the impedance elements between the individual antennae, which determine the respective, electrically-active antenna height of the individual antenna in a reception-frequency-dependent manner.

Additionally, through appropriate dimensioning of the input impedances of the individual base-point electronics, also outside the useful frequency range of the respective individual antenna, a targeted influence on the electromagnetic couplings between the individual antennae and an optimization of the efficiency of the overall arrangement is achieved.

The active individual antennae optimized in this manner are connected via phase matching networks for phase matching of the transmission signals received in the individual antennae with a frequency crossover network for combining the individual phase-matched received signals.

The embodiment of the receiver antenna system with several active individual antennae is explained in greater detail below with reference to the drawings. The drawings are as follows:

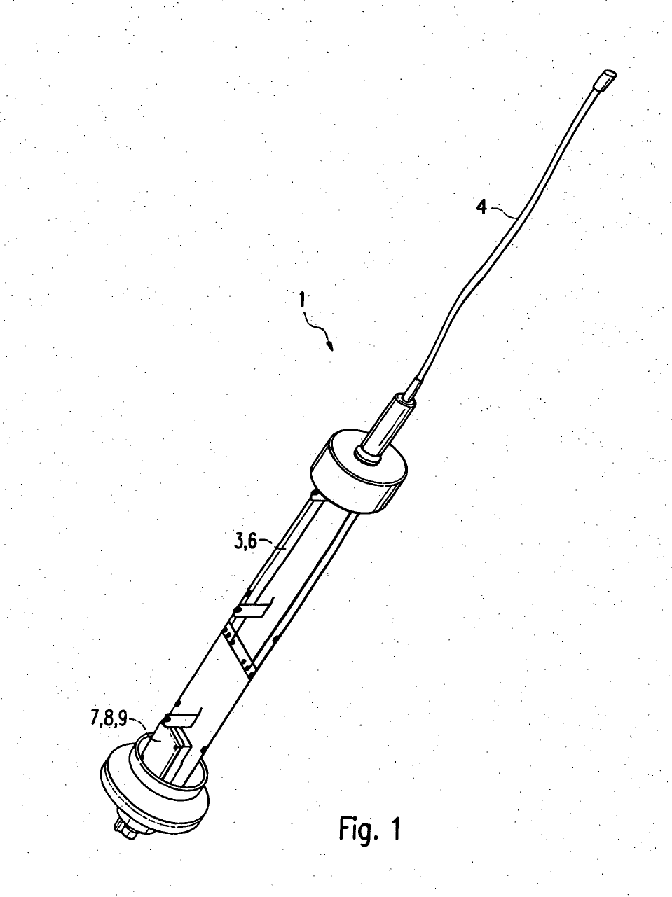

FIG. 1 shows a three-dimensional view of the receiver antenna system according to the invention;

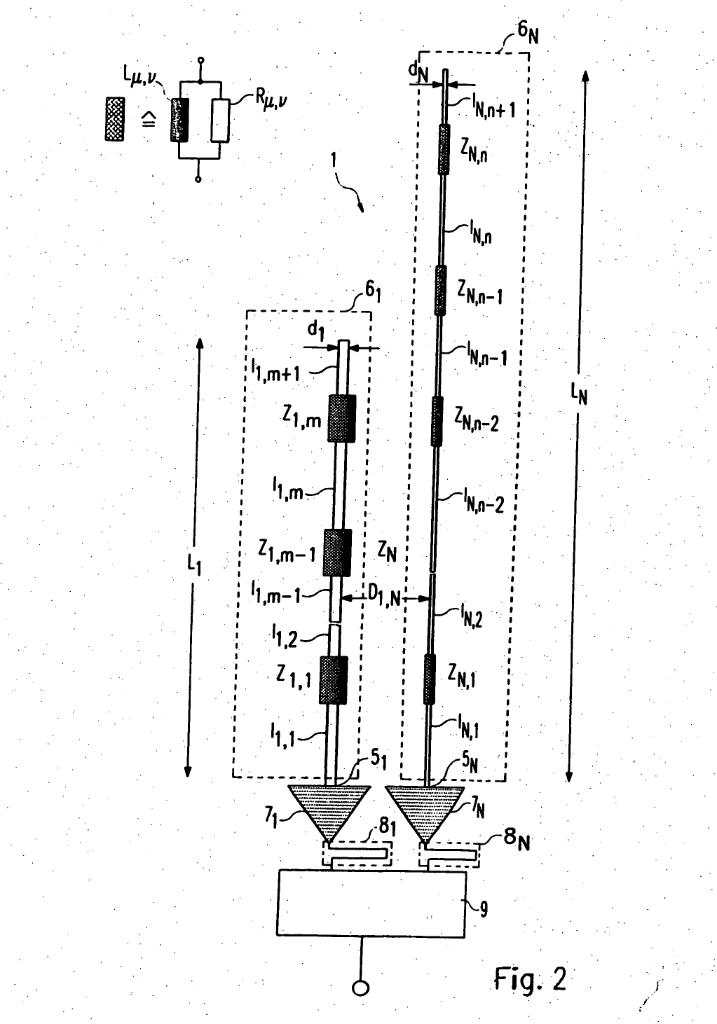

FIG. 2 shows in outline an arrangement of the receiver antenna system according to the invention;

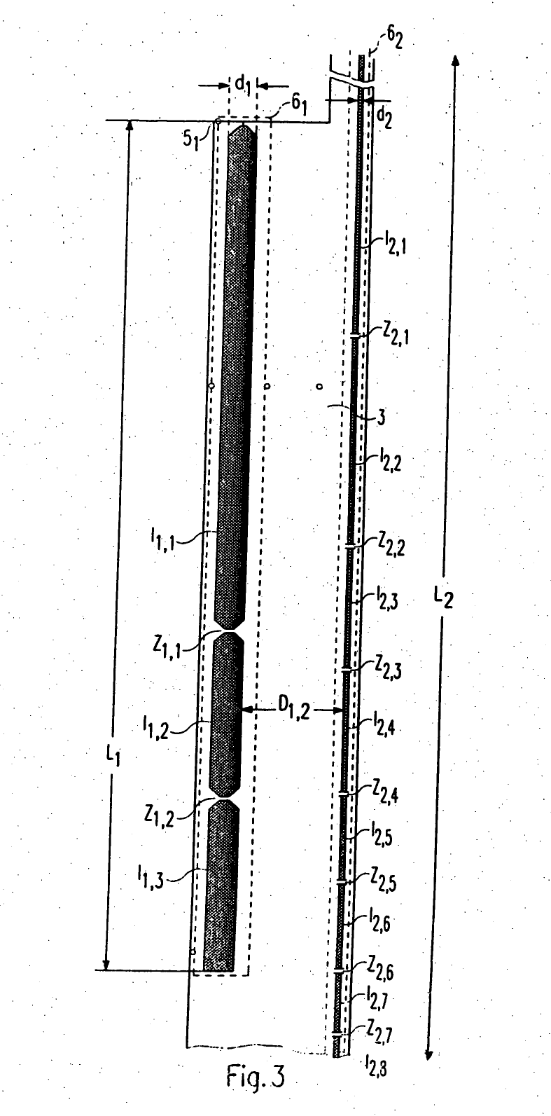

FIG. 3 shows a plan view of the geometry of the passive antenna region of the receiver antenna system according to the invention and

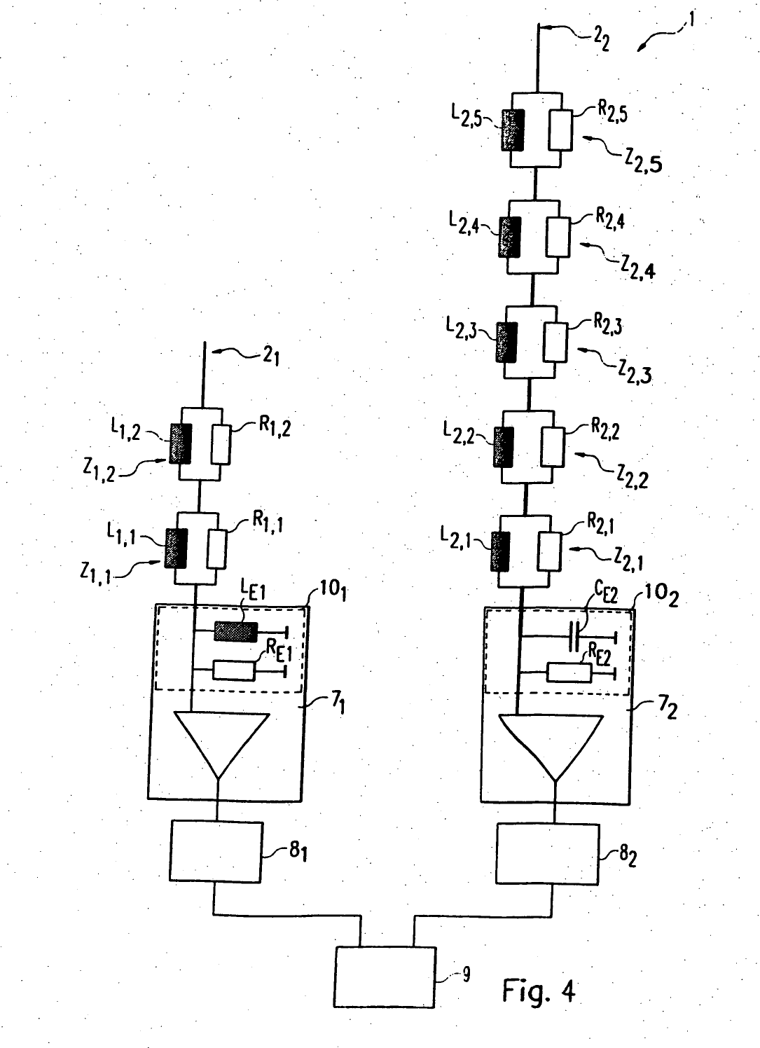

FIG. 4 shows an electrical, block circuit diagram of the receiver antenna system according to the invention.

The receiver antenna system according to the invention as shown in FIG. 1 and FIG. 2 consists of several individual antennae 2₁, 2₂, . . . , 2_{N}, in the minimal configuration, two individual antennae 2₁ and 2₂. These individual antennae 2₁, 2₂, . . . , 2_{N} are attached to a printed circuit board 3 as printed conductors. The antenna receiver system 1 has an extension 4 for the individual antenna with the largest mechanical antenna height, which receives the long-wave transmission signal. For protection, the printed-circuit board 3 with the individual antennae 2₁, 2₂, . . . , 2_{N} is enclosed within a synthetic-material tube.

Each individual antenna 2₁, 2₂, . . . , 2_{N}, has respectively a mechanical antenna height L₁, L₂, . . . , L_{N} and an antenna diameter d₁, d₂, . . . , d_{N}. The individual antennae 2₁, 2₂, . . . , 2_{N}, each provide several printed-conductor portions 1_{μ,ν}, which are connected to one another via impedance elements Z_{μ,ν}. For example, the individual antenna 2₁ in FIG. 2 provides printed-conductor portions 1_{1,1}, 1_{1,2}, . . . , 1_{1,m-1}, 1_{1,m} and 1_{1,m+1}, and the intermittent impedance elements Z_{1,1}, . . . , Z_{1,m-1} and Z_{1,m,} while the individual antenna 2_{N} consists of the printed-conductor portions 1_{N,1}, 1_{N,2}, . . . , 1_{N,n-2}, 1_{N,n-1}, 1_{N,n}, and 1_{N,n+1}, and the intermittent impedance elements Z_{N,1}, . . . , Z_{N,n-2, Z}_{N,n-1} and Z_{N,n}.

The individual impedance elements Z_{μ,ν} consist of a circuit, which provides a very low impedance value with low received frequencies, and which, in the ideal case of a received frequency converging towards zero, short circuits the two adjacent printed-conductor portions 1_{μ,ν} and 1_{μ,ν+1}. By contrast, with high received frequencies, the circuit provides a high real component of the impedance, which, in the ideal case of an infinitely high received frequency, as a pure resistor, suppresses the current flow between the adjacent printed-conductor portions 1_{μ,ν} and 1_{μ,ν+1} and therefore reduces the electrically-active antenna height of the individual antenna 2_{μ}. In this manner, it is possible, through corresponding parametrization of all impedance elements Z_{μ,ν} associated with the respective individual antenna 2_{μ} and their positioning on the individual antenna 2_{μ}, to adjust the electrically-active antenna height of the respective individual antenna 2_{μ} to the optimum antenna height for the respective frequency range of the individual antenna 2_{μ}. In order to realize a frequency-dependent impedance characteristic of this kind, the individual impedance elements Z_{μ,ν} are realised, for example, in a known manner, by a parallel circuit with an inductance L_{μ,ν} and an ohmic resistor R_{μ,ν}. These impedance elements Z_{μ,ν} can be distributed on the individual antennae 2₁, 2₂, . . . , 2_{N} either in a discrete manner or continuously as correspondingly-formed printed conductors.

The respective individual antennae 2_{μ} and 2_{ν} are arranged on the printed-circuit board 3 with a spacing distance of D_{μ,ν}, which is typically a few centimeters. The respective base-points 5₁, 5₂, . . . , 5_{N} of the respective passive antenna regions 6₁, 6₂, . . . , 6_{N} of the individual antennae 2₁, 2₂, . . . , 2_{N} are electrically coupled to the active base-point electronics 7₁, 7₂, . . . , 7_{N}, for example, amplifier elements and/or impedance converters. The passive antenna regions 6₁, 6₂, . . . , 6_{N} can be designed in all radiator structures, such as monopoles, dipoles etc.

Impedance conversion, amplification and coarse filtering—through the frequency response of the respective individual antenna—of the transmission signals received respectively in the passive antenna regions 6₁, 6₂, . . . , 6_{N} of the individual antennae 2₁, 2₂, . . . , 2_{N}, are implemented in the base-point electronics 7₁, 7₂, . . . , 7_{N}.

After their impedance conversion, amplification and filtering in the respective base-point electronics 7₁, 7₂, . . . , 7_{N}, the received transmission signals are phase-matched in the subsequent phase matching networks 8₁, 8₂, . . . , 8_{N}, especially in the overlapping range of the filters of the frequency crossover network of the individual adjacent or overlapping received frequency ranges, in order to guarantee an addition instead of a subtraction of the individual received transmission signals. The phase matching in the individual phase matching networks 8₁, 8₂, . . . , 8_{N} is optimized to such an extent that the maximum possible phase deviation of two received transmission signals is 90°.

After the phase matching in the phase matching networks 8₁, 8₂, . . . , 8_{N}, a band limitation and combination of the individual transmission signals received in the individual antennae 2₁, 2₂, . . . , 2_{N} to form a single overall received signal, which provides an overall reception bandwidth, which corresponds to the sum of all of the individual partial received frequency ranges of the individual antennae 2₁, 2₂, . . . , 2_{N}, takes place in the subsequent frequency crossover network 9.

In FIG. 3, in order to visualise the geometric antenna optimization, a portion of the two passive antenna regions 6₁ and 6₂ printed on a printed-circuit board 3 of the individual antennae 2₁ and 2₂ of the minimal configuration of a receiver antenna system 1 is illustrated for a lower and an upper partial received frequency range respectively. They consist in each case of the printed-conductor portions 1_{1,1}, 1_{1,2}, and 1_{1,3} and 1_{2,1}, 1_{2,2}, 1_{2,3}, 1_{2,4}, 1_{2,5}, 1_{2,6}, 1_{2,7}, 1_{2,8} etc. and the intermittent impedance elements Z_{1,1}, and Z_{1,2}, and Z_{2,1}, Z_{2,2}, Z_{2,3}, Z_{2,4}, Z_{2,5}, Z_{2,6}, Z_{2,7}, ect., which are shown in FIG. 3 not in their concrete interconnection but as free space relative to their positioning. The optimization of the passive antenna regions 6₁ and 6₂ of the individual antennae 2₁ and 2₂ in order to minimize the electromagnetic couplings takes place through an optimum design of the antenna diameters d₁ and d₂, the spacing distance D_{1,2} between the two individual antennae 2₁ and 2₂, the position of the individual impedance elements Z_{μ,ν} relative to one another within the respective individual antennae 2₁ and 2₂ and between the two individual antennae 2₁ and 2₂.

It is evident from FIG. 3 that, according to the invention, with a larger spacing distance relative to the base-points 5₁ and 5₂, the printed-conductor portions 1_{82 ,ν} are increasingly shorter in length. Moreover, it is evident that the length L₁ of the individual antenna 2₁ for the reception of relatively high-frequency transmission signals is designed to be shorter than the length L₂ of the individual antenna 2₂ for the reception of low-frequency transmission signals. Finally, the antenna diameter d₁ of the individual antenna 2₁ for the reception of relatively higher-frequency transmission signals is designed according to the invention to be significantly greater than the antenna diameter d₂ of the individual antenna 2₂ for the reception of relatively low-frequency transmission signals.

In FIG. 4, in order to visualise the electrical optimization, the minimum configuration of the individual antennae from FIG. 3 is presented with the individual antenna 2₁ for the reception of high-frequency transmission signals and the individual antenna 2₂ for the reception of relatively low-frequency transmission signals. According to the invention, the input impedance of the base-point electronics 7₁ of the individual antenna 2₁, which provides a shorter antenna height for reception in the upper frequency range, has a lower value with lower received frequencies. In this manner, low-frequency currents in the individual antenna 2₁ are conducted with low resistance to earth at the input of the base-point electronic 7₁, so that the low-frequency currents coupled from the individual antenna 2₂ to the individual antenna 2₁ do not generate unnecessary losses in the input impedance 10₁ of the base-point electronics 7₁ thereby impairing the efficiency of the antenna 2₂ and do not therefore have a negative influence on the individual antenna 2₂ through electromagnetic parasitic coupling with the adjacent individual antenna 2₁. In order to realise a small input impedance of the base-point electronics 7₁ with low-frequency received signals, a parallel circuit consisting of an inductance L_{E1} and an ohmic resistor R_{E1} is used as the input impedance 10₁ of the base-point electronics. With higher-frequency received signals, the input impedance 10₁ of the base-point electronics 7₁ provides an input impedance matched to the passive antenna structure.

It is also evident from FIG. 4 that the inductances L_{2,ν} in the individual impedance elements Z_{2,ν} become high-resistance on receiving relatively high-frequency transmission signals, and in combination with the resistors on the individual printed-conductor portions 1_{2,ν} of the individual antenna 2₂, behave like a ferritized conductor. Accordingly, relatively high-frequency currents on the individual antenna 2₂ are suppressed. As a result, there is no coupling with the adjacent individual antenna 2₁. With low-frequency received signals, the inductances L_{2,ν} of the impedance elements Z_{2,ν} of the individual antenna 2₂ are of low resistance and do not lead to a suppression of the currents on the individual printed-conductor portions 1_{2,ν} of the individual antenna 2₂. In the overall operating-frequency range, the input impedance 10₂ of the base-point electronic 7₂ provides a high-resistance, capacitive input impedance. The input impedance 10₂ consists of a parallel circuit with a high-resistance resistor R_{E2} and a capacitor C_{E2} with very small capacity.

In general, it can be stated that all of the impedance elements Z_{1,ν} in the individual antenna 2₁ and all of the impedance elements Z_{2,ν} in the individual antenna 2₂ not only perform the function of the frequency-dependent electrical shortening of the respective antenna height, but, by variation of their impedance Z_{1,ν} on the individual antenna 2₁, influence the current I₁ in the individual antenna 2₁ in a targeted, frequency-dependent manner, and, by variation of their impedance Z_{2,ν} on the individual antenna 2₂, influence the current I₂ on the individual antenna 2₂ in a targeted, frequency-dependent manner, and accordingly also minimize the extent of coupling between the two individual antennae 2₁ and 2₂ in a targeted manner.

Alongside the above-named designs, the input impedances 10₁, 10₂, . . . , 10_{N} of the base-point electronics 7₁, 7₂, . . . , 7_{N} are additionally mismatched relative to the base-point impedance of the respective passive antenna regions 6₁, 6₂, . . . , 6_{N} of the individual antennae 2₁, 2₂, . . . , 2_{N} preferably outside the useful frequency range of the individual antenna. In this manner, targeted reflections occur at the inputs of the base-point electronics 7₁, 7₂, . . . , 7_{N}, which have the overall effect of minimizing the electromagnetic couplings between the individual antennae 2₁, 2₂, . . . , 2_{N}.

The invention is not limited to the embodiment presented. In particular, the invention also covers different antenna geometries, different interconnections of the impedance elements and different input interconnections of the base-point electronics.

1. Receiver antenna system of broad bandwidth comprising a plurality of active, vertical individual antennae with an electrically-active antenna height adapted to the respective received frequency range,
wherein
the mutual electromagnetic coupling between the individual antennae, which are positioned at a small spacing distance, is minimized.

2. Receiver antenna system according to claim 1,
wherein
the mutual coupling between the individual antennae is minimized by optimization of individual mechanical and electrically-active antenna heights, individual antenna diameters, spacing distances between individual antennae, and the input impedances of active base-point electronics associated with the individual active antennae.

3. Receiver antenna system according to claim 2,
wherein
the respective electrically-active antenna height is optimized by an optimized arrangement of several impedance elements in the respective individual antennae and their optimized interconnection.

4. Receiver antenna system according to claim 3,
wherein
the optimized arrangement of the impedance elements relative to one another takes place both within one individual antenna and also between the individual antennae.

5. Receiver antenna system according to claim 4,
wherein
the printed-conductor portions between the intermittent impedance elements of each individual antenna are of a shorter length with increasing distance from the base point.

6. Receiver antenna system according to claim 3,
wherein
the interconnection of the impedance elements provides a low impedance in the case of low received frequencies, and provides a high impedance in the case of high received frequencies.

7. Receiver antenna system according to claim 6,
wherein
the interconnection of the impedance elements comprises a parallel circuit comprising an inductance and an ohmic resistor or annular or tubular ferrite cores fitted onto printed conductor portions.

8. Receiver antenna system according to 2,
wherein
the input impedance of the active base-point electronics provides a high-resistance input impedance in those of the individual antennae, which are determined for the reception of low-frequency transmission signals.

9. Receiver antenna system according to claim 8,
wherein
the input impedance of the active base-point electronics comprises a parallel circuit comprising a high-resistance resistor and a low-capacity capacitor in those of the individual antennae, which are determined for the reception of low-frequency transmission signals.

10. Receiver antenna system according to claim 2,
wherein
the input impedance of the active base-point electronics in those of the individual antennae, which are determined for the reception of relatively high-frequency transmission signals, is designed to be of low-resistance for low-frequency transmission signals and to be at the base-point impedance of the passive antenna region of the respective individual antenna for relatively high-frequency transmission signals.

11. Receiver antenna system according to claim 10,
wherein
the input impedance of the active base-point electronics in those of the individual antennae, which are determined for the reception of relatively high-frequency transmission signals, comprises a parallel circuit comprising a resistor and an inductance.

12. Receiver antenna system according to claim 8,
wherein
the input impedance of the active base-point electronics is additionally mismatched in a targeted manner.

13. Receiver antenna system according to wherein 2,
wherein
the received frequency ranges of the individual antennae adjoin one another and form a complete received frequency range.

14. Receiver antenna system according to claim 13,
wherein
phase matching networks for phase matching of the received transmission signals and a crossover network for combining the individual received transmission signals are connected to the passive antenna regions for the reception of transmission signals and to the base-point electronics for the amplification and filtering of the received transmission signals.

15. Receiver antenna system according to claim 12, wherein the input impedance of the active base-point electronics is additionally mismatched in a targeted manner outside the useful frequency range to the base-point impedance of the passive antenna region of the respective individual antenna.
